(19) United States
(12) Patent Application Publication
(10) Pub. No.: US 2003/0144900 A1
(43) Pub. Date: Jul. 31, 2003

(54) Method and system for improving enterprise performance

(76) Inventor: Michael L. Whitmer, Marietta, GA (US)

Correspondence Address: NEEDLE & ROSENBERG, P.C., The Candler Building, Suite 1200, 127 Peachtree Street, N.E., Atlanta, GA, 30303-1811, US

(21) Appl. No.: 10/058,911

(22) Filed: Jan. 28, 2002

(51) Int. Cl. G06F 17/60

(52) U.S. Cl. 705/11

(57) ABSTRACT

The performance of an enterprise including at least one agent is improved using a closed-loop continuous performance method and system. Interactions between the agent and the user are captured, and captured interactions that satisfy predetermined business criteria are recorded. The performance of the agent and the enterprise is evaluated based on the recorded interactions. Other data concerning the agent and the enterprise is analyzed, and training is delivered to the agent based upon the results of the evaluating and analyzing steps, thereby improving the performance of the enterprise.

### BACKGROUND

The present invention is directed to a method and system for improving enterprise performance. More particularly, the present invention is directed to a method and system for improving performance of an enterprise including at least one agent interacting with a user.

As enterprises grow, it is important to keep track of interactions between agents of the enterprise and other parties. For example, as businesses grow, it is important to keep track of customer service contacts.

The customer interaction center is where current and potential customer's experience first-hand an enterprise's services, produce, and brand. Quality of service provided by the customer service representatives is an important factor in determining the success of a business.

Today, collaboration across the entire enterprise is becoming critical to building and optimizing customer relationships. Without strong collaboration, these relationships may be weakened, and there is a strong risk that customers will move on to the competition.

There is thus a need for a method and system for distributing information representing customer interactions throughout an enterprise. There is also a need for targeting training to agents, based on this information, to improve the transactions between agents and other parties.

### SUMMARY

The present invention is directed a method and system for improving performance of an enterprise including at least one agent, such as a customer service agent, that interacts with at least one user, such as a customer.

According to exemplary embodiments, interactions between the agent and the user are captured, and captured interactions that satisfy predetermined business criteria are recorded. Interactions that satisfy predetermined business criteria may include, for example, interactions that result in a sale greater than a predetermined number of dollars or a sale of a particular product, last longer than a predetermined period of time, involve a particular agent, are from a particular calling party, are to a particular number, or are of a predetermined priority.

According to one embodiment, only the selected captured interactions are recorded. According to another embodiment, all of the captured interactions are recorded, and the interactions that do not satisfy the predetermined business rules are discarded.

The performance of the agent and the enterprise is evaluated based on the recorded interactions. Other data concerning the agent and the enterprise is analyzed, including, for example, historical and statistical data concerning the agent and the enterprise. Targeted training is delivered to the agent based upon the results of the evaluating and analyzing steps, thereby improving the performance of the enterprise

According to one embodiment, the recorded interactions may be distributed throughout the enterprise for evaluation. For example, the recorded interactions may be distributed to customer service, business development, support, and marketing groups within the enterprise for evaluation. The recorded interactions may also be distributed outside the enterprise for evaluation. The recorded interactions may include web, e-mail, telephone, order entry, customer relationship management, customer business applications, voice commerce, kiosk, self-service and/or interactive voice response exchanges.

According to one embodiment, the interactions that satisfy predetermined business criteria are automatically recorded. In another embodiment, the agent initiates recording of the interactions. According to yet another embodiment, recording is initiated by a third party.

Further objects, advantages and features of the present invention will become more apparent when reference is made to the following description taken in conjunction with the accompanying drawings.

### BRIEF DESCRIPTION OF THE DRAWINGS

FIG. 1 illustrates an exemplary closed-loop method according to an exemplary embodiment; and

FIG. 2A illustrates an exemplary system for selectively recording interactions according to an exemplary embodiment;

FIG. 2B illustrates an exemplary system for evaluating recorded interactions according to exemplary embodiments;

FIG. 2C illustrates an exemplary system for analyzing overall performance according to exemplary embodiment; and

FIG. 2D illustrates an exemplary system for training according to an exemplary embodiment.

### DETAILED DESCRIPTION

According to exemplary embodiments, a closed-loop continuous performance improvement process allows for the rules-based recording of customer interactions across all channels (e.g., web, email, telephone), the evaluating of agent performance, the analysis of overall performance metrics, and the prioritization and delivery of targeted training based upon the evaluations and analysis.

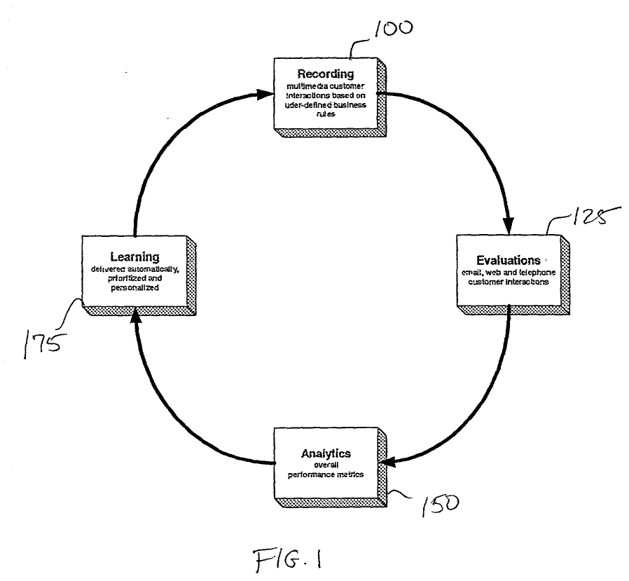

FIG. 1 illustrates an exemplary closed loop system for continually improving performance of an enterprise, such as a customer contact center including at least one agent communicating with customers. As shown in FIG. 1, transmitted multimedia data is selectively recorded at step 100 based upon certain business-driven rules. The multimedia data may include, for example, voice, data, e-mail, web, fax, integrated voice response (IVR data), etc.

The multimedia data may correspond to interactions between a customer service representative at a company and an end user. For example, a transmission may include e-mail communications or web pages that are sent back and forth between an end user seeking assistance from the customer service department of a company.

The selectively recorded multimedia data is then evaluated at step 125 and analyzed along with other data at step 150 by, for example, the person responsible for supervising the customer service agent. If it turns out through the analysis that the customer service agent is not doing an effective job in a certain area (e.g., the customer service agent is not adequately answering the customer's questions), then a learning management system may be automatically initiated at step 175, whereby the customer service agent is temporarily relieved of his/her duties in answering questions from customers, and a tutorial pops up on the agent's computer screen. The tutorial may be directed to the area where the agent needs additional training.

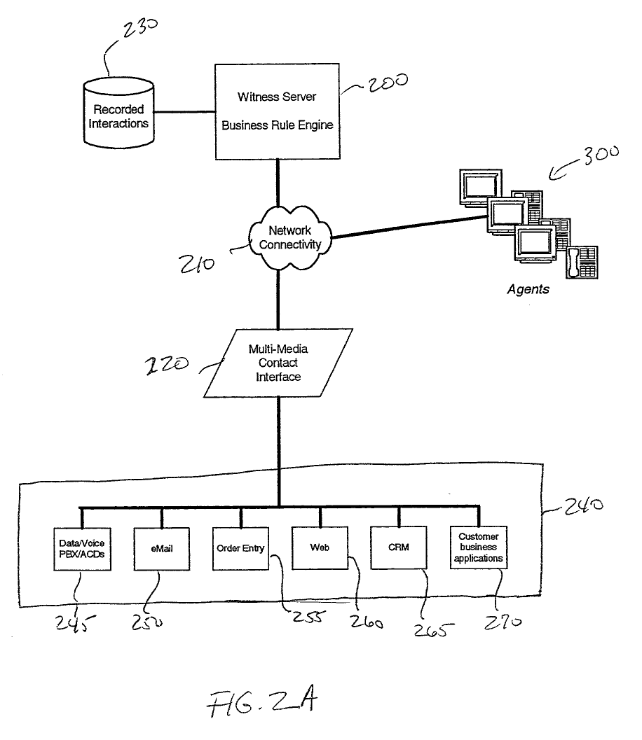

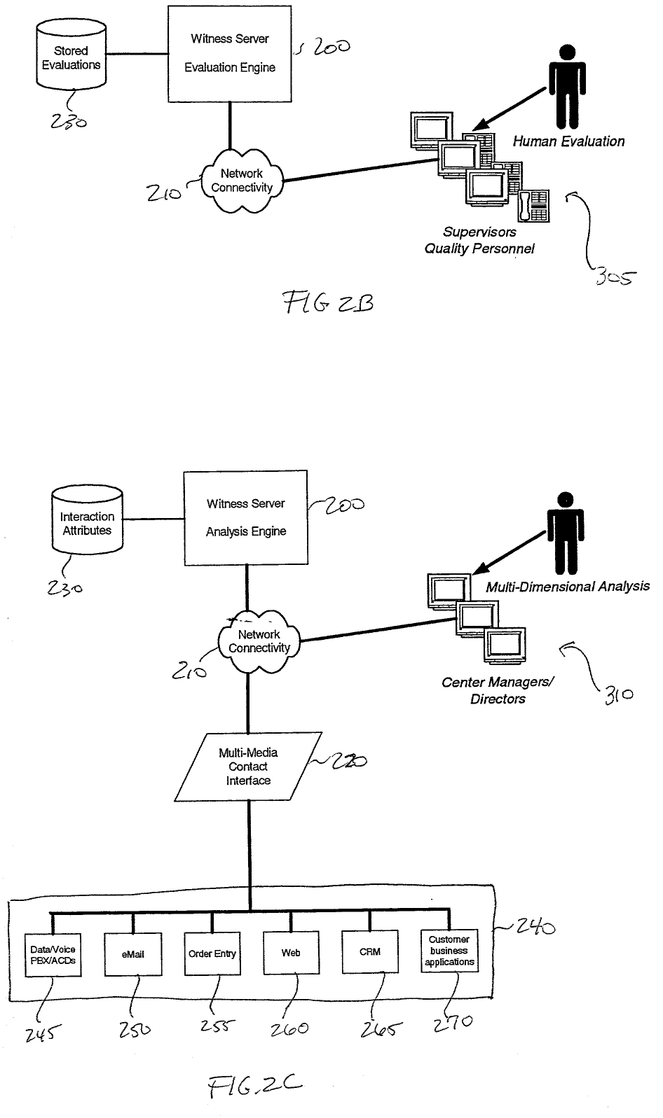

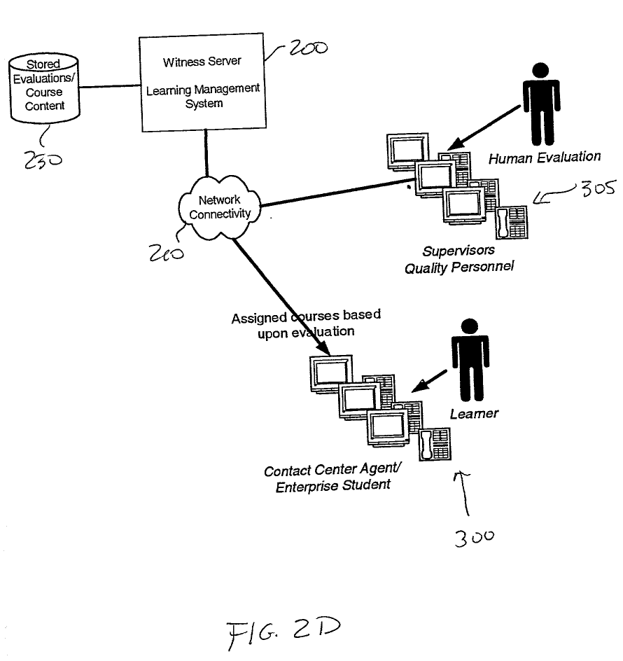

FIG. 2A illustrates an exemplary system for selectively recording interactions. The system includes a server 200 that collects data from interactions between agents and customers. The interactions occur via a network 210. Third party applications for sending or receiving data to the server communicate via a multimedia contact interface 220. The users may include users communicating via user interfaces 240 which may include a data voice private branch exchange/automatic call device (PBX/ACD) 245, an order entry 250, e-mail 255, web 260, customer relationship management (CRM) 265, customer business applications 270, or other user interfaces. Agents communicate via agent interfaces 300, which may include, e.g., telephone and computer terminals.

According to an exemplary embodiment, only captured data that satisfies predetermined business rules is recorded. Thus, the server 200 collects data selected from the interactions over the network 210 that satisfies predetermined business rules. According to an exemplary embodiment, captured attributes and content are analyzed in, for example, a Business Rule Engine (BRE) at the server 200, to determine whether they satisfy predetermined business rules. Data that satisfies these rules may be recorded in a database 230. A user may be notified of customer contact center transactions.

According to another embodiment, all captured data may be recorded, and the data that does not satisfy predetermined business rules may be discarded. This ensures that the entire interaction is captured. If the storage capacity is large enough, this can, in effect, capture interactions in the past.

The terminology “business rules” has a commonly accepted meaning in the art and in this context refers to business elements for comparison with captured data in real time. Examples of comparison of captured data with business rules include determining whether an interaction resulted in a sale greater than a predetermined number of dollars, determining whether an interaction lasted longer than a predetermined number of minutes, etc. Business rule comparison may be made active or inactive on a defined schedule.

According to an exemplary embodiment, recording call center transactions may begin with an end-user identifying all of the contact mediums and the associated attributes that they are interested in analyzing or recording. Then, the user establishes rules that are evaluated by the BRE. When activated, the system begins recording the attributes and caching the content of all transactions that an end-user identified. Simultaneously, the BRE processes thousands of events that contain the attributes that have been identified by the end-user. The BRE evaluates these attributes against the defined rules and determines whether or not the cached content should be stored in the content repository. Also, the BRE notifies the appropriate personnel via page, email, or voicemail. The repository contains the attributes of all transactions that were analyzed as well as the content of those transactions that met certain business rule criteria.

According to another embodiment, data may be captured by capturing only changed areas of an agent's screen to minimize network utilization. This is described in more detail in commonly assigned U.S. Pat. No. 5,790,798, incorporated herein by reference.

According to another embodiment, random agent and event monitoring is provided in which a percent of sample size of contacts is automatically monitored and recorded for future playback. Live monitoring is also provided, in which monitoring for both voice and data or real-time contact may be initiated, and these contacts may then be recorded. For this purpose, a list of agents and their status may be displayed. If an agent, e.g., a customer service representative (CSR), is on a call, the Dialed Number Identification Service (DNIS) number, which is the internal representation of an 800 number, may also be displayed if available. For example, if a customer calls 1-800FLOWERS, the call center will assign a number like “341768” as the DNIS. Then when an agent gets the call, the agent may see this DNIS on the screen and know that the caller called 1-800-FLOWERS.

According to another embodiment, agents 300 may also initiate recording of real-time contacts, e.g., when there is a serious complaint or customer feedback about a new product or service is being provide by a customer. Agents may also disable monitoring for a particular call for various purposes, e.g., if a customer requests it for legal purposes.

After-call monitoring may also be provided, by which an agent's screen actions after the contact ends are monitored or recorded. For example, an agent may wait until after the customer hangs up to enter information that could have been entered during a call. This type of situation offers an excellent training opportunity. Agents may be monitored from any point, based, e.g., on login information from the switch.

Also, customer transactions may be documented and retained by capturing the customer's verbal authorization. This voice signature capability simplifies the sale process and reduces costs by leveraging verbal rather than written authorization for certain types of transactions, such as consumer debits authorized over the telephone.

According to exemplary embodiment, recorded interactions may be placed into a designated folder for easy access, retrieval and replay. The entire interaction may be retained, whether the business rule is triggered prior to the contact, e.g., for automatic number identification (ANI), DNIS, or agent ID, during the contact, e.g., according to priority, a product request, or a completed sale, or at the end of the interaction, based e.g., on the length of contact. The folders may be maintained by agents, e.g., customer service representatives, and managers. Contact folders may be made available for training (coaching), marketing (campaign results) and engineering (product feedback).

Certain people or groups may be notified via, e.g., e-mail, pager or mobile device when they should evaluate a critical customer interaction.

After recording takes place, end-users may create custom forms to be used in the evaluation of recorded interactions. These forms are then used to evaluate and score each interaction based upon the appropriate criteria identified by the end-user. The scored evaluations are then used as a component of the agent overall performance measurement.

FIG. 2B illustrates an exemplary system for evaluating recorded interactions. Interactions may be viewed by any user authorized to access, retrieve, and replay contacts, create and review evaluations, and create, retrieve and analyze reports. Evaluations may be performed by an evaluation engine included in the server 200 or a separate server. Supervisors may review evaluations via stations 305 that may be connected, e.g., via the Intranet, to the server 200. These stations may be similar to those 300. Recorded interactions may also be posted to the Intranet site to be replayed using a multimedia player, such as Microsoft® Window Media™ or RealNetwork® RealPlayer®.

Contacts may also be exported to non-system users, with proper security. The contact content may be converted, e.g., into audio video interleaved (AVI) media files for this purpose and distributed via, e.g., e-mail.

An events list may be stored and retrieved for each contact, allowing the entire flow of the interaction to be followed. The entire contact may be reviewed, or only specific segments of the interaction may be reviewed. Contact events include, for example, transfers, agent-initiated monitoring, hold times (recording activity from the CSR's perspective), annotations, conferences (including all parties on the call), etc.

Notes may be added by voice or text annotations to any recorded customer contact. The annotation may be made public or kept private for only the creator or designated users to access.

For telephone exchanges, voice conversations between agents and customers are combined with the keystrokes and data being input into the agent's desktop (screen capture). By uniting these two components, contact center supervisors may replay recorded interactions a synchronized format.

For e-mail exchanges, specified contacts may be recorded and evaluated. This may be integrated with leading e-mail response mangement applications. Also, web and collaborative chat interactions may be recorded and analyzed. This ensures that the customer receives the highest quality response.

Evaluations may be stored in a database, e.g., the database 230 or a separate database.

After evaluations are complete, the data is fed to the analytic engine and combined with other disparate data from the contact center to create a repository of data that is used to measure and analyze the overall performance of the enterprise.

FIG. 2C illustrates an exemplary system for multi-dimensional analysis. Data from throughout the contact center is combined, accessed, and explored to pinpoint the relationship between various metrics (such as ACD, predictive dialing, workforce management, evaluations, training, customer satisfaction, customer relationship management (CRM), etc.). Another example is the effect call control skills have on average talk time. This provides a better understanding of the effect one performance metric has on another. These metrics may be specified by the system owner.

Referring to FIG. 2C, analysis is performed via an analytic engine that may be included in the server 200 or in a separate server. Center managers and directors perform the analysis via stations 310. The results are recorded as interaction attributes in a database, e.g., the database 230 or a separate database.

Finally, through evaluation and analysis, agent skill set and competency deficiencies are identified, and specific training is automatically assigned and delivered, e.g., to the agent's desktop, via the learning management component. Thus, according to exemplary embodiments, identification, scheduling, and delivery of personalized online training are provided. Then, the individuals that are assigned training may be subsequently scheduled for further recording to ensure that the learning took place and the entire closed-loop process continues.

FIG. 2D illustrates an exemplary system for delivering training according to an exemplary embodiment. Agents 300 receive training based on stored evaluations and course content in a database, such as the database 230. The training is delivered by the learning management system, which may be included in the server 200 or in a separate server. Supervisors may also take part in the training via stations 305.

According to the invention, advantages include increased customer loyalty and revenue, rapid return on investments, reduced costs. Also, the invention enables communication of vital intelligence across a company, identification of important trends, and evaluation and optimization of the performance of people, processes, and technology.

By recording customer interactions across all media, including telephone, email, and web exchanges, evaluating agent performance, and then using those evaluations to prioritize and deliver targeted training, contact centers have an integrated, closed-loop system for continuously improving performance in the contact center.

It should be understood that the foregoing description and accompanying drawings are by example only. A variety of modifications are envisioned that do not depart from the scope and spirit of the invention. The above description is intended by way of example only and is not intended to limit the present invention in any way.

What is claimed is:

1. A method for improving performance of an enterprise including at least one agent that interacts with at least one user, the method comprising the steps of:
capturing interactions between the agent and the user;
recording interactions among the captured interactions that satisfy predetermined business criteria;
evaluating the performance of the agent and the enterprise, based on the recorded interactions;
analyzing other data concerning the agent and the enterprise; and
delivering targeted training to the agent based upon the results of the evaluating and analyzing steps, thereby improving the performance of the enterprise.

2. The method of claim 1, wherein the step of recording the selected interactions includes recording only the selected interactions.

3. The method of claim 1, wherein the step of recording the selected interactions includes recording all the captured interactions and discarding the interactions that do not satisfy predetermined business criteria.

4. The method of claim 1, wherein the step of evaluating includes distributing the recorded interactions are distributed throughout the enterprise for evaluation.

5. The method of claim 1, wherein the recorded interactions are distributed outside the enterprise for evaluation.

6. The method of claim 4, wherein the recorded interactions are distributed to customer service, business development, support, and marketing groups within the enterprise for evaluation.

7. The method of claim 1, wherein the user is a customer, and the agent is a customer service agent.

8. The method of claim 1, wherein the recorded interactions include at least one of web, e-mail, telephone, order entry, customer relationship management, customer business applications, voice commerce, kiosk, self-service and interactive voice response exchanges.

9. The method of claim 1, wherein interactions that satisfy predetermined business criteria include interactions that result in a sale greater than a predetermined number of dollars or a sale of a particular product, last longer than a predetermined period of time, involve a particular agent, are from a particular calling party, are to a particular number, or are of a predetermined priority.

10. The method of claim 1, wherein the interactions that satisfy predetermined business criteria are automatically recorded.

11. The method of claim 1, wherein the agent initiates recording of the interactions that satisfy predetermined business criteria.

12. The method of claim 1, wherein a third party initiates recording of the interactions that satisfy predetermined business criteria.

13. The method of claim 1, wherein the other data analyzed includes historical and statistical data concerning the agent and the enterprise.

14. A system for improving performance of an enterprise including at least one agent that interacts with at least one user, the system comprising:
a recorder for recording captured interactions between the agent and the user that satisfy predetermined business criteria;
an evaluator for evaluating performance of the agent and the enterprise based on the recorded interactions;
an analyzer for analyzing other data concerning the agent and the enterprise; and
a training device for delivering targeted training to the agent based upon the results of the evaluating and analyzing, thereby improving the performance of the enterprise.

15. The system of claim 14, wherein the recorder records only captured interactions that satisfy the predetermined business criteria.

16. The system of claim 14, wherein the recorder records all the captured interactions and discards interactions that do not satisfy the predetermined business criteria.

17. The system of claim 14, wherein the recorded interactions are distributed throughout the enterprise for evaluation.

18. The system of claim 14, wherein the recorded interactions are distributed outside the enterprise for evaluation.

19. The system of claim 17, wherein the recorded interactions are distributed to customer service, business development, support, and marketing groups within the enterprise for evaluation.

20. The system of claim 14, wherein the user is a customer, and the agent is a customer service agent.

21. The system of claim 14, wherein the recorded interactions include at least one of web, e-mail, telephone, customer relationship management, order entry, customer business applications, voice commerce, kiosk, self-service and interactive voice response exchanges.

22. The system of claim 14, wherein interactions that satisfy predetermined business criteria include interactions that result in a sale greater than a predetermined number of dollars or a sale of a particular product, last longer than a predetermined period of time, involve a particular agent, are from a particular calling party, are to a particular number, or are of a predetermined priority.

23. The system of claim 14, wherein the interactions that satisfy predetermined business criteria are automatically recorded.

24. The system of claim 14, wherein the agent initiates recording of the interactions that satisfy predetermined business criteria.

25. The system of claim 14, wherein a third party initiates recording of the interactions that satisfy predetermined business criteria.

26. The system of claim 14, wherein the other data analyzed includes historical and statistical data concerning the agent and the enterprise.
